(19) United States
(12) Patent Application Publication
(10) Pub. No.: US 2024/0289720 A1
(43) Pub. Date: Aug. 29, 2024

(54) SYSTEM AND METHOD FOR IMPLEMENTING A DATA ANALYSIS SUBSTANTIVE PROCEDURE FOR REVENUE TRANSACTIONS

(71) Applicant: KPMG LLP, New York, NY (US)

(72) Inventors: Alissa Wuerfel, Ridgewood, NJ (US); Douglas K. Besch, Hopatcong, NJ (US); Heike Drake-Cavalletti, Minneapolis, MN (US); Sydelle Harrison, San Francisco, CA (US); Keith Hooper, Arlington, VA (US); Robert Hunter, Ellicott City, MD (US); Angela Norris, Chicago, IL (US); Samarth Patel, Frisco, TX (US); Roy Steward, State College, PA (US); Anne C. Zavarella, Grandview Heights, OH (US); David Zipkin, Philadelphia, PA (US)

(21) Appl. No.: 18/588,541

(22) Filed: Feb. 27, 2024

Related U.S. Application Data
(60) Provisional application No. 63/448,481, filed on Feb. 27, 2023.

(51) Int. Cl. G06Q 10/0635

(52) U.S. Cl. CPC G06Q 10/0635

(57) ABSTRACT

The invention relates to computer-implemented systems and methods for implementing a Revenue Data Analysis Tool to perform a data analysis substantive procedure to obtain sufficient and appropriate audit evidence to respond to the risks of material misstatements associated with revenue transactions.

### CROSS REFERENCE TO RELATED APPLICATIONS

The application claims priority to U.S. Provisional Application No. 63/448,481 (Attorney Docket No. 055089.0000098), filed Feb. 27, 2023, the contents of which are incorporated by reference herein in their entirety.

### FIELD OF THE INVENTION

The present invention generally relates to revenue data analysis and more specifically to a revenue data analysis tool that applies to a data analysis risk assessment and/or data analysis substantive procedure for various transactions, e.g., point-in-time or certain over-time revenue transactions, vendor related expenses, contra-revenue transactions, etc.

### BACKGROUND

Generally, revenue can be recognized over time or at a point in time. A performance obligation is considered satisfied and revenue can be recognized when a customer obtains control of an asset or benefits from a service provided. For example, revenue is recognized at a point in time when control of the good or service is transferred to the customer.

Oftentimes, revenue is not properly recognized due to misstatements concerning when control is transferred. This can result in revenue not being recognized in the correct period.

It would be desirable, therefore, to have a system and method that could overcome the foregoing disadvantages of known systems.

### SUMMARY

According to an embodiment, the invention relates to a computer-implemented system that implements a data analysis risk assessment and substantive procedure for revenue transactions. The system comprises: a data input that receives one or more of: transactional data and general ledger data for an entity; a memory component that stores and manages the one or more: transactional data and the general ledger data; and a computer processor that is coupled to the data input and further programmed to perform the steps of: receiving input data comprising one or more of: current year and previous year transactional data and general ledger data; identifying, through an optionality feature, a set of data analysis routines; applying the set of data analysis routines to the input data to analyze one or more of: revenue general ledger and transaction-level-data; calculating a score for each of the set of data analysis routines applied to each of the one or more of: transaction and general ledger data using a points model; based at least in part on the score, categorizing each of the one or more of: transaction and general ledger data into a set of groups that determine whether a set of expectations are met; based on the set of groups, accumulating audit evidence accordingly; and generating and transmitting an output based at least in part on the score and the set of groups.

According to another embodiment, the invention relates to a computer-implemented method that implements a data analysis risk assessment and substantive procedure for revenue transactions. The method comprises the steps of: receiving, via a data input, input data comprising one or more of: current year and previous year transactional data and general ledger data; identifying, through an optionality feature, a set of data analysis routines; applying, via a computer processor, the set of data analysis routines to the input data to analyze one or more of: revenue general ledger and transaction-level-data; calculating, via the computer processor, a score for each of the set of data analysis routines applied to each of the one or more of: transaction and general ledger data using a points model; based at least in part on the score, categorizing, via the computer processor, each of the one or more of: transaction and general ledger data into a set of groups that determine whether a set of expectations are met; based on the set of groups, accumulating, via the computer processor, audit evidence accordingly; and generating and transmitting, via an interface, an output based at least in part on the score and the set of groups.

The invention also relates to a computer-readable medium containing program instructions for executing a method that implements a data analysis risk assessment and/or substantive procedure for revenue transactions.

An embodiment of the present invention is directed to a Revenue Data Analysis Tool that is data-driven and technology-enabled by multiple routines supporting a single, robust, substantive procedure that is efficient and insightful. With an embodiment of the present invention, general ledger data may be analyzed to provide insights into account pairings such as when revenue is being recognized and accounts receivable is being cleared. In addition, transactional data may be analyzed through various statistical and nonstatistical analysis providing insights, for example, into customer sales patterns, size of transactions, etc. Transactions reduce audit risk when they meet expectations and are properly categorized for further analysis. An embodiment of the present invention provides an alternative to traditional sampling approaches over the population to allow for focus and/or resources to be placed on only those items that did not meet expectations. This approach increases audit quality by analyzing the relevant transactions, providing audit insights, and also achieves efficiencies by reducing resources and expenses.

According to an embodiment of the present invention, transactions and/or general ledger data may be categorized into groupings based on a score received through a set of routines. Other determinations, metrics and/or calculations may be applied. For example, the score may represent a number of points accumulated through the set of routines. In this example, transactions and or general ledger data meeting the expectations of the analysis are generally considered to have accumulated sufficient and appropriate evidence to conclude without further procedures.

According to an exemplary illustration, items may be categorized into groups, such as lower category items, moderate category items and higher category items. In this example, lower category items represent items that met expectations and have accumulated sufficient and appropriate audit evidence, require no additional audit procedures, except to add unpredictability in some cases. Moderate category items may require additional procedures, which may include procedures such as management inquiry and corroboration. Higher category items may require additional procedures, which may include procedures such as management inquiry and a test of details (e.g., sampling or other detailed testing approach). In addition, a combination of procedures may be used to analyze entries booked to unexpected accounts, including a test of details. Other categories at varying levels and granularity may be applied.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flow diagram, according to an embodiment of the present invention.

FIG. 2 illustrates exemplary thresholds applied to categorize transactional and/or general ledger data into groupings based on the score received through the set of applied routines, according to an embodiment of the present invention.

FIG. 3 is an exemplary set of routines, according to an embodiment of the present invention.

FIG. 4 illustrates exemplary routines, according to an embodiment of the present invention.

FIG. 5 illustrates an exemplary Revenue journal entry (JE) Pairing flowchart, according to an embodiment of the present invention.

FIG. 6 illustrates an exemplary journal entry (JE) pairing segregation logic, according to an embodiment of the present invention.

FIG. 7 illustrates an exemplary interface, according to an embodiment of the present invention.

FIG. 8 illustrates an exemplary interface, according to an embodiment of the present invention.

FIG. 9 illustrates an exemplary interface, according to an embodiment of the present invention.

FIG. 10 illustrates an exemplary interface, according to an embodiment of the present invention.

FIG. 11 illustrates an exemplary interface, according to an embodiment of the present invention.

### DETAILED DESCRIPTION

Exemplary embodiments of the invention will now be described to illustrate various features of the invention. The embodiments described herein are not intended to be limiting as to the scope of the invention, but rather are intended to provide examples of the components, use, and operation of the invention.

An embodiment of the present invention is directed to a Revenue Data Analysis Tool designed to perform a data analysis substantive procedure to obtain sufficient and appropriate audit evidence to respond to risks associated with revenue transactions, such as point-in-time revenue transactions. The risks may relate to misstatements, for example. Other types of risks may be contemplated by the various embodiments of the present invention and range of applications/scenarios. The innovative system may apply to revenue with varying assessed risk. An embodiment of the present invention is directed to a set of routines that operate generally at the subledger or transaction level, but may also operate at the general ledger level. Using a predetermined points model, each routine may be assigned a maximum number of points that a transaction can achieve. An embodiment of the present invention may implement various points systems, scoring methodologies, etc.

Risks of material misstatements may relate to various scenarios. For example, for performance obligations satisfied at a point in time, revenue may not be recognized when control is transferred to the customer, resulting in revenue not being recognized in the correct period or elements of the transaction price are not completely and accurately identified.

According to an embodiment of the present invention, a set of relevant risks may include the following: performance obligations satisfied at a point in time, an inaccurate amount is recorded for revenue; and revenue is not accurately recorded because the transaction price is not appropriately determined. Other risks and considerations may be considered.

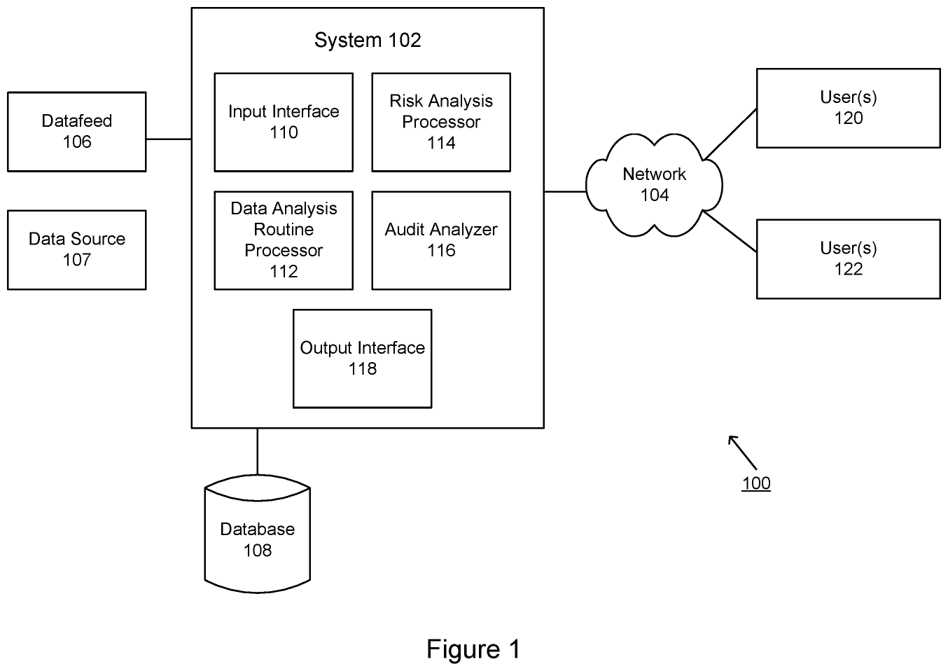

FIG. 1 is an exemplary system diagram, according to an embodiment of the present invention. According to an embodiment of the present invention, analyzed transactions may be categorized into predetermined categories (e.g., low, medium, high) based on score received through a set of applied routines. The predetermined threshold to categorize the transactions may be adjusted within the Revenue Data Analysis Tool based on other factors such as the assessed audit risk, meaning as the assessed risk increases more points are required to meet expectations. An embodiment of the present invention may perform additional procedures over items such as: corroboration for moderate residual risk, and test of details for higher residual risk.

As shown in FIG. 1, User(s) 120, 122 may access System 102 via Network 104. System 102 may receive data from various sources represented by Datafeed 106, Data Source 107 which may include internal as well as external sources of information. System 102 may be a stand-alone system or integrated with various other systems and platforms. Other implementations and architectures may be supported.

System 102 may support various features and functions represented by Input Interface 110, Data Analysis Routine Processor 112, Risk Analysis Processor 114, Audit Analyzer 116, Output Interface 118, etc.

Input Interface 110 may receive/ingest input data from various data sources, including Datafeed 106, Data Source 107. Input data may include Current Year (CY) and/or Previous Year (PY) transactional data and/or CY General Ledger (GL) data. Database 108 may store and manage data, analytics, reports, etc.

With Data Analysis Routine Processor 112, an embodiment of the present invention may perform a combination of different data analysis routines to analyze revenue general ledger and/or transaction-level-data. An embodiment of the present invention provides an optionality feature in the routines selected for execution.

With Risk Analysis Processor 114, data may be assigned a score using a predetermined points model.

Audit Analyzer 116 may perform testing over items categorized as requiring additional audit procedures.

Output Interface 118 may represent an interactive interface that provides analysis in various formats, including dashboards, interactive interfaces, and/or other communications. Output Interface 118 may be accessed by various user devices over communication network represented by Network 104. For example, Output Interface 118 may include various interfaces such as dashboards, Excel output and testing templates, revenue journal entry (JE) pairing as well as risk assessments.

Journal entry may represent a record of business transaction, economic or non-economic, for an organization or entity. A journal entry may contain information, such as date, amount credited/debited, transaction description and/or accounts affected, for a single business transaction. For example, journal entries may detail how transactions affect accounts and balances.

Users 120, 122 may communicate with System 102 via Network 104. System 102 may communicate and integrate with other devices and support various configurations and architectures. System 102 may support interactions on devices including mobile or computing device, such as a laptop computer, a personal digital assistant, a smartphone, a smartwatch, smart glasses, other wearables or other computing devices capable of sending or receiving network signals. System 102 may include computer components such as computer processors, microprocessors and interfaces to support applications including browsers, mobile interfaces, dashboards, interactive interfaces, etc. Other functions and features represented may be supported in various forms and implementations. While FIG. 1 illustrates individual devices or components, it should be appreciated that there may be several of such devices to carry out the various exemplary embodiments.

System 102 may be communicatively coupled to various data sources, as shown by Database 108, including any suitable data structure to maintain the information and allow access and retrieval of the information. Data Sources may be local, remote, cloud or network based. Communications with Data Sources may be over a network, or communications may involve a direct connection.

Networks may be a wireless network, a wired network or any combination of wireless network and wired network. Although Network 104 is depicted as one network for simplicity, it should be appreciated that according to one or more embodiments, Network 104 may comprise a plurality of interconnected networks, such as, for example, a service provider network, the Internet, a cellular network, corporate networks, or even home networks, or any of the types of networks mentioned above. Data may be transmitted and received via Network 104 utilizing a standard networking protocol or a standard telecommunications protocol.

The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 are depicted, it should be appreciated that other connections and relationships are possible. The system 100 described below may be used to implement the various methods herein, by way of example. Various elements of the system 100 may be referenced in explaining the exemplary methods described herein.

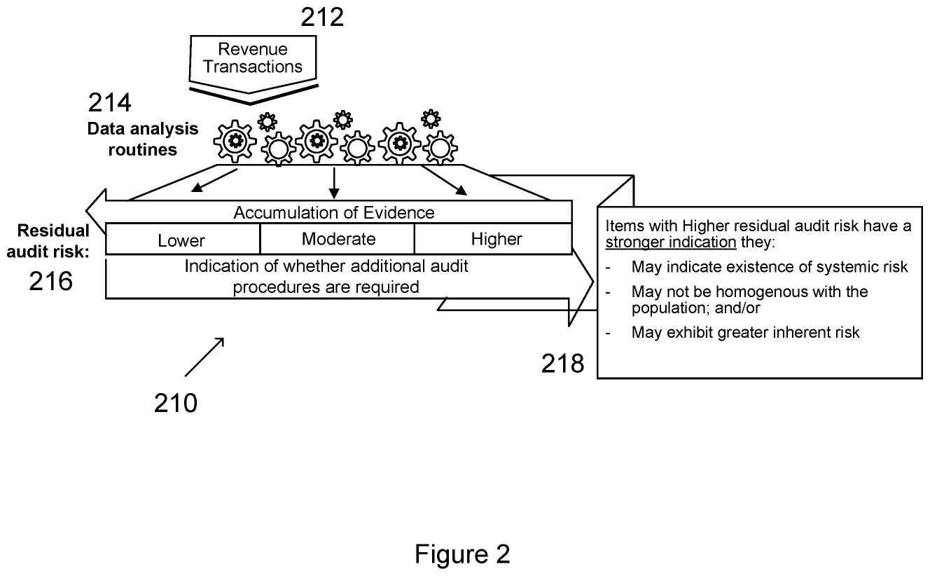

FIG. 2 illustrates exemplary thresholds applied to categorize transactional and/or general ledger data into groupings based on the score received through the set of applied routines, according to an embodiment of the present invention. For example, exemplary thresholds may determine whether sufficient and appropriate audit evidence has been obtained, according to an embodiment of the present invention. Sufficient and appropriate audit evidence may be identified by points (or other metric or measurement) and depending on what range the points fall, an embodiment of the present invention may determine whether expectations are met or not met.

As shown by 210, revenue transactions 212 may go through data analysis routines 214. During the process, evidence may be accumulated based on a score, and a predetermined set of points, for example, may be determined. Depending on the categorization 216 (e.g., lower, moderate, higher), an indication of whether additional audit procedures are required to obtain sufficient and appropriate audit evidence may be determined.

For example, as shown by 218, items with higher residual audit risk may indicate existence of systemic risk; may not be homogenous with the population; and/or may exhibit greater inherent risk.

If transactions are identified that exhibit systemic risk or otherwise do not meet the engagement criteria, they may be removed from the population. Separate procedures may be performed over these transactions.

An embodiment of the present invention may be directed to selecting a combination of routines. For example, engagement teams may select which routines to execute. An embodiment of the present invention may automatically determine an optimal set of routines for execution. This may be further enhanced and refined through artificial intelligence/machine learning. An embodiment of the present invention may determine whether transactions meet routine specific criteria and whether the required relevant data elements (RDEs) are available. Based on the routine selection, an embodiment of the present invention may consider how many total points are possible and whether there are enough to constitute sufficient and appropriate audit evidence.

An embodiment of the present invention may apply a JE (Journal Entries) Pairing routine, which may be considered optional. When evaluating whether to execute the routine, an embodiment of the present invention may consider the complexity of the entity's process for recording journal entries in a process such as the sales and collection processes. When selected, an embodiment of the present invention may execute the routine over the same or more periods that were executed through the rest of the Revenue Data Analysis Tool, and the results may, for example, be evaluated to receive a predetermined number of points to determine whether sufficient and appropriate audit evidence has been obtained. Other scoring schemes and/or point methodologies may be applied, including categories such as red, yellow and green.

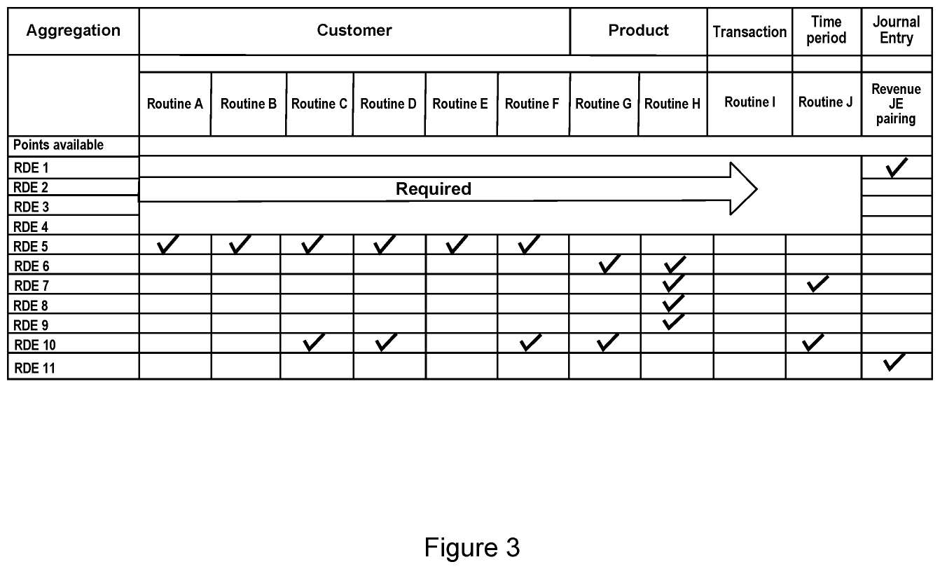

FIG. 3 is an exemplary set of routines, according to an embodiment of the present invention. FIG. 3 identifies information about each routine including the aggregation (e.g., customer, product, transaction, time period, journal entry, etc.), points available, and the required data elements to run the routine, as shown by RDE 1-RDE 11. For example, required data elements may include: amount, document identifier, fiscal year, period, customer identifier, product identifier, date, price per unit, quantity, PY data, GL account number, etc. While transactions may be tested and ultimately scored at an individual item level, each routine may score items by various aggregations. For example, if scored by a customer, all items for that customer may get the same number of points for that routine. Other variations may be realized.

Routines may be aggregated by customer, product, transaction, time period, journal entry, etc. As shown in FIG. 3, routines relating to customers may include: Routines A-F. Routines relating to products may include: Routines G-H. Transaction routine may include: Routine I. Time period routine may include: Routine J. Journal entry routine may include: Revenue journal entry pairing routine. Other routines may be supported.

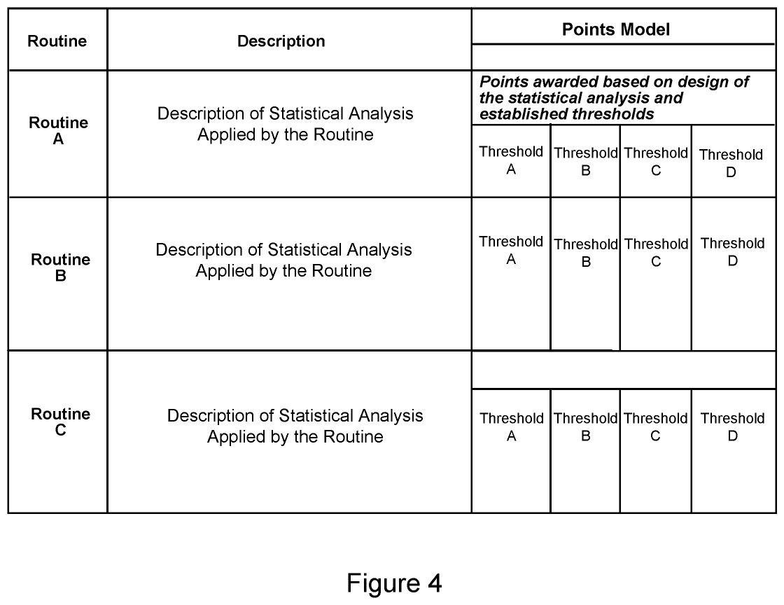

FIG. 4 illustrates exemplary routines, according to an embodiment of the present invention. For each Routine, details may include: Description and Points Model. For example, for the Routine A points model, points may be awarded based on a statistical model. Various thresholds may be applied. According to other example, for another Routine, points may be awarded based on a data science model. Various models may be applied to the points models. Various thresholds may be applied.

An embodiment of the present invention is directed to testing relevant data elements and inputs. For example, an embodiment of the present invention may test the reliability of internal RDEs and engagement-specific inputs foundational to the use of the Revenue Data Analysis Tool.

In addition, an embodiment of the present invention may consider whether any additional RDEs not outlined in the Routine Summary (e.g., Customer or Product Name) may assist in the performance of additional audit procedures for items categorized as requiring additional audit procedures. The system may further perform appropriate testing procedures over additional RDEs.

Once Routines have been determined to be relevant, RDEs have been tested and appropriate user inputs have been determined, an embodiment of the present invention may be ready to execute the Revenue Data Analysis Tool.

An embodiment of the present invention may be directed to pre-processing or preparing data. Pre-processing may relate to addressing negatives, formula errors, and blanks. Transactions may be analyzed to determine if they meet a criteria, such as an engagement criteria. Those that do, may be left in the population. Those that do not, may be excluded from the Revenue Data Analysis Tool. Separate procedures may be performed over these transactions. The revised population excluding these transactions may be re-run through the Revenue Data Analysis Tool, adjusting the inputs and applied thresholds for aggregation risk if the transactions remain in the same significant account. Any formula errors (e.g., DIV/0!, #N/A!, #NAME?, #NULL, #NUM!, #REF!, #VALUE) may be considered and addressed before executing, as necessary. For example, if a customer number reads as a #NULL value on import because of a formula error, it may be pulled in as blank and not associated with the appropriate customer if not corrected prior to execution.

According to an embodiment of the present invention, for example, only certain transactions relating to Revenue may be an input into the Revenue Data Analysis Tool. For example, transactions such as returns or financing components may be excluded as these transactions have inherent and control risks distinct from those tested by the Revenue Data Analysis Tool.

The routine may filter out certain transactions that will need to be considered separately. For example, if there are transactions with missing relevant data elements, those may be removed by the Revenue Data Analysis Tool and subject to audit procedures performed outside the Revenue Data Analysis Tool.

Data relating to separate significant accounts may be separated into distinct analyses. For example, if there are two streams of revenue which have separate processes, risks, and controls and both streams of revenue are eligible to be tested by the Revenue Data Analysis Tool, an embodiment of the present invention may separate the data for each revenue stream into two separate analyses based on the significant account determination.

An embodiment of the present invention is directed to a Revenue JE Pairing Routine that is designed to determine, for example, if journal entries recorded to specified accounts meet expected characteristics (e.g., revenue accounts or Trade Accounts Receivable). An account level summary may be provided for evaluation. To receive points for the JE Pairing routine (e.g., a predetermined number of points), centralized and engagement-specific expectations need to be met. The JE Pairing and Subledger routines may be executed using two separate workflows.

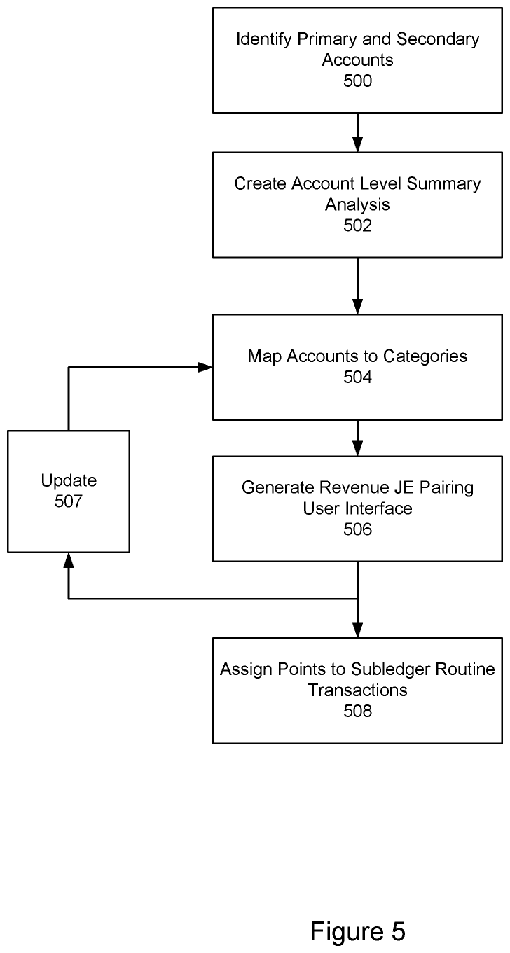

FIG. 5 illustrates an exemplary Revenue JE Pairing flowchart, according to an embodiment of the present invention. Step 500 may involve identifying primary and secondary accounts for analysis. For example, a user may identify the accounts for analysis. At step 502, Account Level Summary Analysis may be created. A JE Pairing segregation logic may detail how accounts may be classified and procedures performed over the output. At step 504, accounts may be mapped to pre-defined categories and document expectations. Accounts may be classified by the tool and procedures performed over the output. At step 506, a user interface, such as a Revenue JE Pairing interface for example, may be populated and results may be evaluated. In turn, these results may lead to an update of the account mapping, as shown by 507. At step 508, a predetermined set of points may be assigned to transactions when the subledger routine is executed.

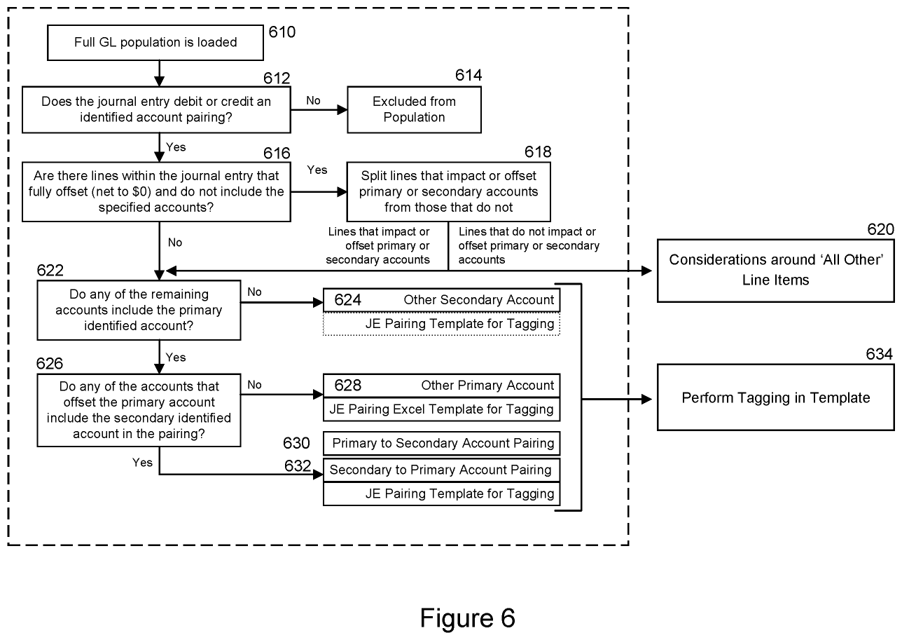

FIG. 6 illustrates an exemplary JE Pairing segregation logic, according to an embodiment of the present invention. The JE pairing routine may use the logic displayed to separate line items in various ways. Those that offset (directly or indirectly) the accounts may be tagged in the output. Those that do not impact the accounts are also output for consideration.

At step 610, a general ledger (GL) population data may be loaded.

At step 612, a determination may be made whether the journal entry debits or credits specified (primary and secondary) accounts. If none, the journal entry may be excluded from the GL population at step 614. At step 616, a determination may be made whether there are lines within the journal entry that fully offset (e.g., net to $0) and do not include specified accounts. If yes, step 618 splits lines that impact or offset specified accounts from those that do not.

For lines that do not impact or offset specified accounts, step 620 may consider “all other” line items. These line items may be unrelated to an objective of the routine. A review of the summary of “All Other Line Items” in a user interface may involve: verifying they have no impact to specified accounts, and (if necessary) investigating any entries that do impact specified accounts. Also, this may involve considering whether any of the account pairings are significant and may be contradictory to a process understanding in other areas of the audit.

For lines that impact or offset specified accounts, step 622 may determine whether any of the remaining accounts include the identified specified accounts. If yes, step 626 may determine whether any of the accounts that offset specified accounts include other specified accounts. For other entries related to the secondary account (624), other entries related to the primary account (628), entries that impact the primary account to the secondary account (630) and entries that impact the secondary account to the primary account (632), tagging may be performed at step 634.

Tagging may be performed in a Template. For example, a tagging interface may include a set of tabs, e.g., four tabs corresponding to 624, 628, 630 and 632. This may involve reviewing instructions to tag and document each account; tagging accounts that do not meet engagement team expectation as unexpected or unevaluated; and loading and evaluating results into an interface.

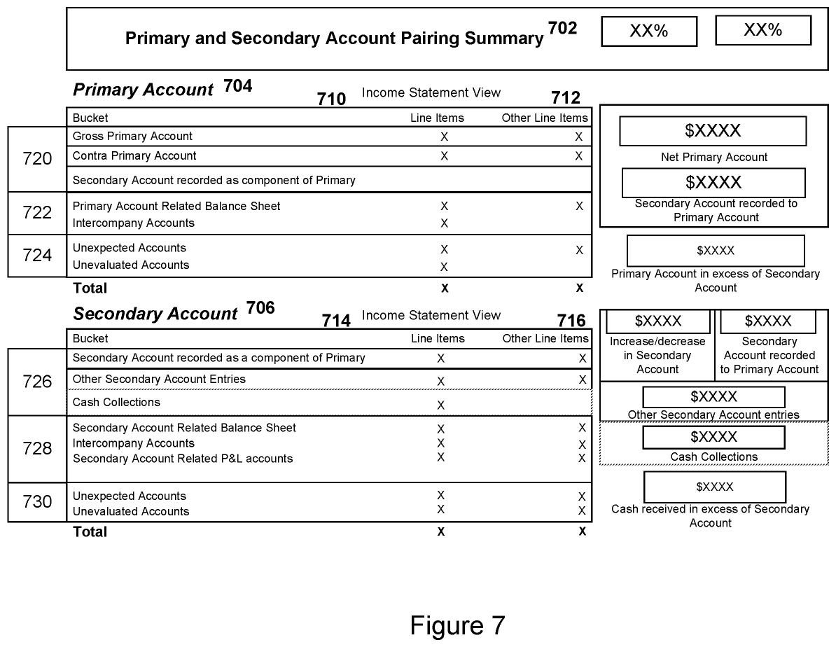

FIG. 7 illustrates an exemplary interface, according to an embodiment of the present invention. FIG. 7 illustrates a Summary of specified accounts at 702. The interface may include Primary Account Summary, as shown by 704, and Secondary Account Summary, as shown by 706.

Summary 704 may include entries meeting centralized expectations 720, entries meeting engagement-specific expectations 722 and unexpected/unevaluated entries 724.

Summary 706 may include entries meeting centralized expectations 726, entries meeting engagement-specific expectations 728 and unexpected/unevaluated entries 730.

FIG. 7 also shows a summary of line items from journal entries containing a debit or credit to the primary and secondary specified accounts, as shown by 710 and 714.

Section 712 may represent a summary of line items from journal entries containing a debit or credit to the primary specified account and no debit or credit to secondary specified account.

Section 716 may represent a summary of line items from journal entries containing a debit or credit to the secondary specified account and no debit or credit to the primary specified account (e.g., entries that clear A/R).

A drill through option may display line items that make up the balance. For example, a user may drill through a line item to view/access the full underlying journal entry.

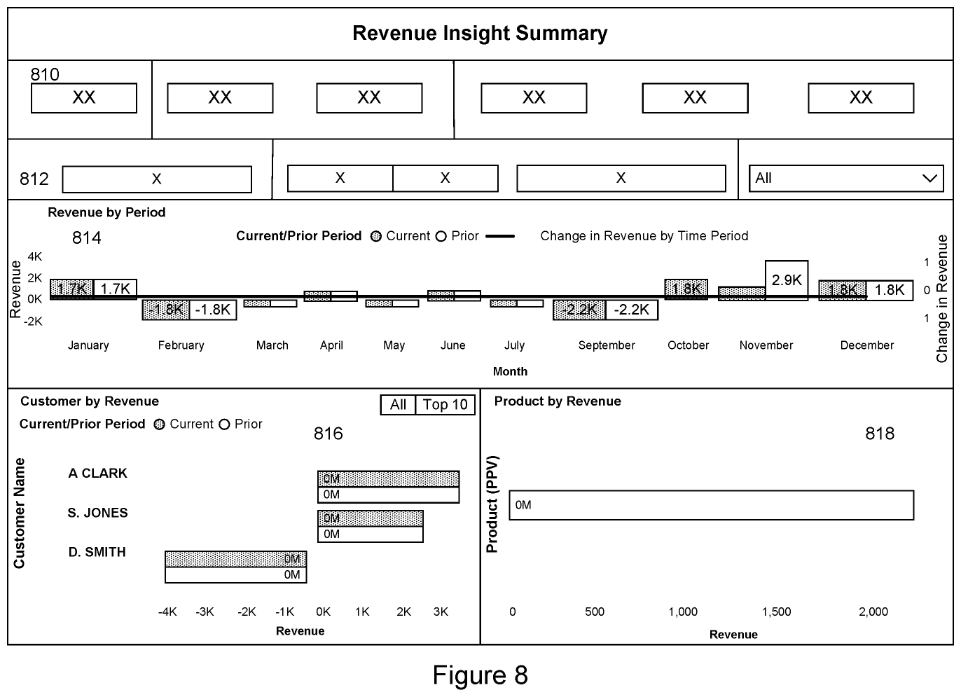

FIG. 8 illustrates an exemplary interface, according to an embodiment of the present invention. FIG. 8 is an exemplary revenue insight summary interface that provides information regarding the overall results of the Revenue Data Analysis Tool as well as data to assist in confirming risk assessment. The insights interface enables users to consider any potentially contradictory information obtained while reviewing.

As shown in FIG. 8, revenue summary may be provided at 810; insight details at 812; revenue by period graphic 814; customer by revenue graphic 816; and product by revenue 818.

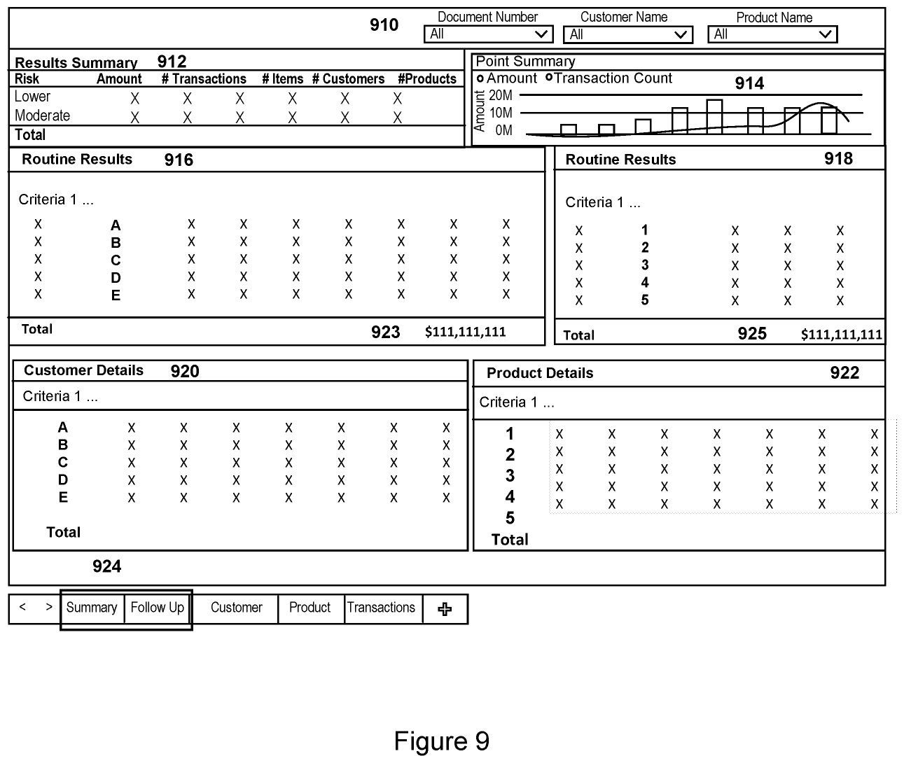

FIG. 9 illustrates an exemplary interface, according to an embodiment of the present invention. As shown in FIG. 9, a follow-up interface may include summary and follow-up tabs.

Section 910 may represent tables or other graphic that may be filtered for any transaction, customer, or product, by selecting from dropdown.

As shown by 912, a Results Summary provides a total of items within each category. Interacting with the categories may filter details of those transactions/customers/products as shown in FIG. 9.

As shown by 916, Transaction Detail may display transactions and the points received for the set of routines that were applied. If a routine is not applied, the points may be blank. For example, for transactions meeting a threshold, a predetermined value may be displayed.

As shown by 918, Product Detail may display products and the points received for the routines that were applied based on a product level (if applicable).

As shown by 914, visual of amounts and count of items by points may be provided. Other graphics may be supported.

As shown by 923, 925, as individual products may represent a sub-set of transactions (e.g., lines items of total invoices), the total amount may be displayed.

As shown by 920, 922, Customer and Product Details may display attributes of customers and products, respectively. This may assist with understanding customers or products within a certain grouping when filters are added.

Section 924 illustrates various tabs, including Summary and Follow Up. The Follow Up tab may be filtered to only display items requiring follow up, regardless of what other filters are added.

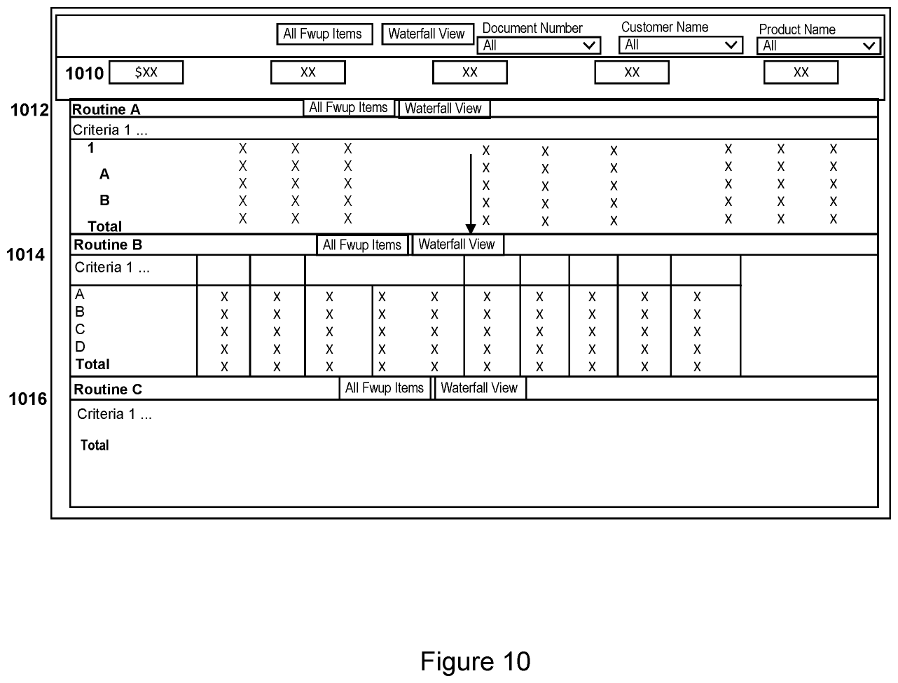

FIG. 10 illustrates an exemplary interface, according to an embodiment of the present invention. FIG. 10 illustrates a Summary Section 1010; Customers requiring additional audit procedures 1012; Customer requiring additional audit procedures 1014 and Customers requiring additional audit procedures 1016.

An amount for any customer that has any transactions exceeding a threshold may be displayed.

Additional attributes may be provided to assist with performing additional audit procedures.

For moderate and higher categories, the user interface may show the total dollar amount of items within that customer, time period, product, or transaction (depending on the aggregation of the table) that did not obtain sufficient and appropriate audit evidence from the Revenue Data Analysis Tool and require additional audit procedures. This may be applicable for some or all tables in the user interfaces.

The user interface may show the count of individual items requiring additional audit procedures. This may be applicable for some or all tables in the user interface. The user interface may show the dollar amount of items that were above a predetermined threshold. This information may assist when performing additional audit procedures.

In addition, the user interface may provide an option to show products within each customer that did not obtain sufficient and appropriate audit evidence from the product routines and the dollar amount of the items for that Product that require additional audit procedures. This information may assist when performing additional audit procedures.

Information on Routines may be provided to assist with performing additional audit procedures.

Tables may be blank if there are no items exhibiting that characteristic and/or some or all items exhibiting that characteristic may be included in another table.

Drill through capabilities may provide additional details about a given item on any tab within the user interface. This may include: a summary that displays all items within the item clicked and/or that only displays items that did not obtain sufficient and appropriate audit evidence within the item clicked.

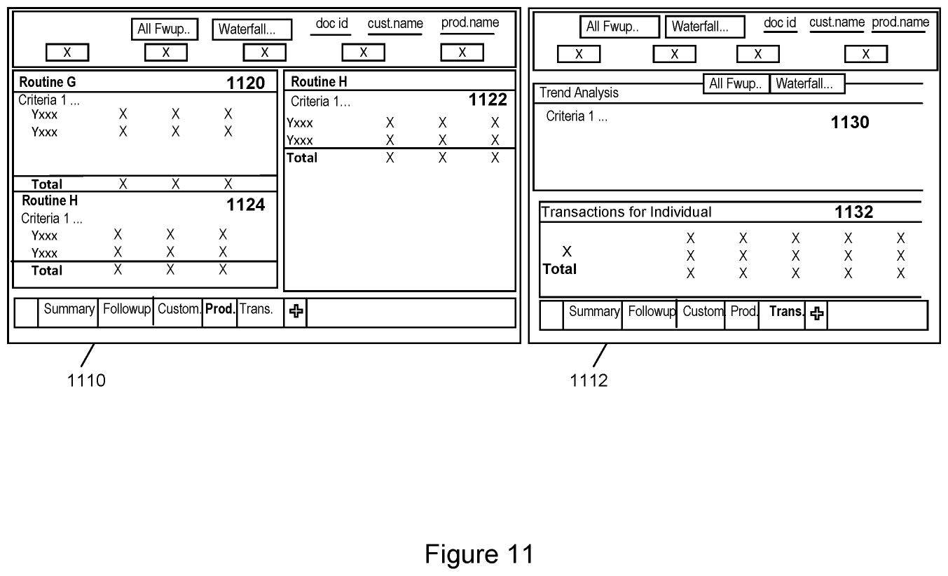

FIG. 11 illustrates an exemplary interface, according to an embodiment of the present invention. As shown in FIG. 11, user interface may include product and transactions tabs. For Products 1110, FIG. 11 illustrates transactions from Routine G 1120; Details of Routine H 1122; and Transactions from Routine H 1124. For Transactions 1112, FIG. 11 illustrates Trend Analysis 1130 for a time period and Transactions for Individual Follow up 1132.

Section 1120 may provide data regarding whether a transaction met a specific threshold for a routine, e.g., Routine D.

Section 1122 may display any transactions that received points from Routine E, along with detailed information to assist with performing additional audit procedures.

As shown by 1124, transactions that received points from Routine F may be displayed by product. Interacting with or clicking on a product may populate additional detained information that may assist with performing additional audit procedures.

Section 1130 may represent the result of the analysis applied by a routine. The score for each respective time period may be displayed based on the predetermined logic of the routine.

Section 1132 may include transactions that did not obtain sufficient and appropriate audit evidence, but did not exhibit any of the characteristics used to filter the other tables. These may be displayed as individual transactions or grouped by an unique identifier, such as customer.

According to an embodiment of the present invention, a summary of cut-off risk assessment analysis over a time period may be provided based on analysis of a variety of factors.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages will be apparent to those skilled in the art from consideration of the specification and practice of the embodiments disclosed herein. The specification and examples should be considered exemplary.

What is claimed is:

1. A computer-implemented system that implements a data analysis risk assessment and substantive procedure for revenue transactions, the system comprising:
a data input that receives one or more of: transactional data and general ledger data for an entity;
a memory component that stores and manages the one or more: transactional data and the general ledger data; and
a computer processor that is coupled to the data input and further programmed to perform the steps of:
receiving input data comprising one or more of: current year and previous year transactional data and general ledger data;
identifying, through an optionality feature, a set of data analysis routines;
applying the set of data analysis routines to the input data to analyze one or more of: revenue general ledger and transaction-level-data;
calculating a score for each of the set of data analysis routines applied to each of the one or more of: transaction and general ledger data using a points model;
based at least in part on the score, categorizing each of the one or more of: transaction and general ledger data into a set of groups that determine whether a set of expectations are met;
based on the set of groups, accumulating audit evidence accordingly; and
generating and transmitting an output based at least in part on the score and the set of groups.

2. The system of claim 1, wherein the set of data analysis routines comprise one or more of: customer routines, product routines, transaction routines, time period routines and revenue journal entry (JE) pairing.

3. The system of claim 2, wherein the revenue journal entry (JE) pairing comprises determining whether at least one journal entry recorded to specified accounts meets a set of expected characteristics.

4. The system of claim 1, wherein the revenue transactions comprise point-in-time or certain over-time revenue transactions.

5. The system of claim 1, wherein the score comprises a predetermined set of points.

6. The system of claim 1, wherein the set of groups is based on one or more analyzed metrics.

7. The system of claim 6, wherein the set of groups is based on categorization of one or more items that determine whether sufficient and appropriate audit evidence has been obtained.

8. The system of claim 6, wherein the set of groups is based on categorization of one or more items that provides an indication of the extent of one or more additional audit procedures to perform.

9. The system of claim 1, wherein the output comprises grouping the processed data for items not accumulating sufficient and appropriate audit evidence in a logical order to perform one or more additional audit procedures.

10. The system of claim 9, wherein the one or more additional procedures comprises: management inquiry, corroboration, and a testing of details.

11. A computer-implemented method that implements a data analysis risk assessment and substantive procedure for revenue transactions, the method comprising the steps of:
receiving, via a data input, input data comprising one or more of: current year and previous year transactional data and general ledger data;
identifying, through an optionality feature, a set of data analysis routines;
applying, via a computer processor, the set of data analysis routines to the input data to analyze one or more of: revenue general ledger and transaction-level-data;
calculating, via the computer processor, a score for each of the set of data analysis routines applied to each of the one or more of: transaction and general ledger data using a points model;
based at least in part on the score, categorizing, via the computer processor, each of the one or more of: transaction and general ledger data into a set of groups that determine whether a set of expectations are met;
based on the set of groups, accumulating, via the computer processor, audit evidence accordingly; and
generating and transmitting, via an interface, an output based at least in part on the score and the set of groups.

12. The method of claim 11, wherein the set of data analysis routines comprise one or more of: customer routines, product routines, transaction routines, time period routines and revenue journal entry (JE) pairing.

13. The method of claim 12, wherein the revenue journal entry (JE) pairing comprises determining whether at least one journal entry recorded to specified accounts meets a set of expected characteristics.

14. The method of claim 11, wherein the revenue transactions comprise point-in-time or certain over-time revenue transactions.

15. The method of claim 11, wherein the score comprises a predetermined set of points.

16. The method of claim 11, wherein the set of groups is based on one or more analyzed metrics.

17. The method of claim 16, wherein the set of groups is based on categorization of one or more items that determine whether sufficient and appropriate audit evidence has been obtained.

18. The method of claim 16, wherein the set of groups is based on categorization of one or more items that provides an indication of the extent of one or more additional audit procedures to perform.

19. The method of claim 11, wherein the output comprises grouping the processed data for items not accumulating sufficient and appropriate audit evidence in a logical order to perform one or more additional audit procedures.

20. The method of claim 19, wherein the one or more additional procedures comprises: management inquiry, corroboration, and a testing of details.
